(19) United States
(12) Patent Application Publication
(10) Pub. No.: US 2016/0050248 A1
(43) Pub. Date: Feb. 18, 2016

(54) DATA-STREAM SHARING OVER COMMUNICATIONS NETWORKS WITH MODE CHANGING CAPABILITIES

(71) Applicant: SILENT STORM SOUNDS SYSTEM, LLC, San Francisco, CA (US)

(72) Inventors: George I. Gayl, San Francisco, CA (US); Sarah L. Thomas, San Francisco, CA (US); Pavlo Taikalo, Kyiv (UA); Pavlo Bashmakov, Kyiv (UA); Sergy Kovalenko, Kyiv (UA)

(21) Appl. No.: 14/458,141

(22) Filed: Aug. 12, 2014

(51) Int. Cl. H04L 29/06; H04L 29/08

(52) U.S. Cl. CPC H04L 65/60; H04L 67/06

(57) ABSTRACT

Systems and methods are provided for allowing mobile device to switch modes from stream controllers to listeners/receivers. In stream controller mode a mobile device may control numerous data streams from local and remote locations in a network and manipulate the streams before multicasting or broadcasting them to listeners/receivers. Listeners/receivers may be able to choose from numerous stream controllers when more than one are available on a particular network.

### FIELD

The subject matter described herein relates generally to a system and method for controlling and sharing data-streams over communications networks with the ability to change modes from a stream controller to a stream receiver and from a stream receiver to a stream controller.

### BACKGROUND

Many social functions involve listening to music. Listening to music in some social settings may involve a live band or prerecorded music tracks playing and the use of equipment to amplify the audio signals and project them to the audience. As such, the audience may hear the amplified audio signals and enjoy the beat and melodies of the music. Since audio amplification and projection may result in loud volumes which are audible over distances, individuals in the vicinity of the event but not in the audience may hear the music even if they do not wish to, thus intruding on their peace. Other examples of useful implementations of the invention may include events such as political rallies or music festivals where numerous points of interest may exist in a localized area such as an arena, convention center, or fairground and where noise becomes a major issue and can interfere with each point of interest.

A “silent disco”, sometimes referred to as a “headphone event”, is a common name for a party, event, or other gathering where individuals may listen to multicast or broadcast music on wireless headphones. This allows individuals to hear the music and personally adjust the volume of the music based on the individuals own preferences. Use of headphones also helps to reduce the sound audible to individuals who are not tuning in to the broadcast and who may be disturbed by a loud audio projection of the broadcast. Silent disco events are sometimes popular in areas where local government has enacted noise curfews because they produce no loud audio signals. Silent disco events are also sometimes popular in mobile club gatherings or other flash mob type incidents.

Modernly, the concept of a silent disco is gaining popularity and has led to a greater demand for silent disco type events. In turn, this has led to a demand for broader and more varied applicability. Since many people now carry vast libraries of music around with them on a day-to-day basis using personal audio players, laptop computers, and other portable data storage devices they may wish to share music in-person with friends, family, coworkers, or other people and even be a disc jockey (“DJ”) master of ceremonies (“MC”), or other music coordinator or performer.

As such, improved methods and systems of audio sharing may be desirable.

### SUMMARY

Provided herein are embodiments of a method and system of controlling and sharing data streams over networks. Typically a silent disco event consists of listeners tuning in to a broadcast by a single or small number of DJ's. In a typical silent disco event specialized hardware may be required in order to achieve the best synchronization of music streams to listeners and there is no opportunity for listeners to become broadcasters themselves using mobile devices which have become increasingly common.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is an example view of a basic network setup according to an embodiment of the present invention.

FIG. 1B is an example view of a network connected server system according to an embodiment of the present invention.

FIG. 1C is an example view of a user device according to an embodiment of the present invention.

FIG. 2 is a block diagram depicting an example embodiment of a typical network structure and flow chart for data in a Wi-Fi network in accordance with the present invention.

FIG. 3 is a sequence diagram depicting a 1D typical data sequence over a Wi-Fi network in accordance with the present invention.

FIG. 4 is a block diagram depicting an example embodiment of a typical network structure and flow chart for data in a 3G network in accordance with the present invention.

FIG. 5 is a sequence diagram depicting a typical data sequence over a 3G network in accordance with the present invention.

FIG. 6A is an example embodiment of a user interface of a mobile device in a stream controller mode in accordance with the present invention.

FIG. 6B is an example embodiment of a user interface of a mobile device in a listener/receiver mode in accordance with the present invention.

FIG. 6C is an example embodiment of a user interface of a mobile device in an audio stream access screen in accordance with the present invention.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

Although many of the examples below describe music embodiments it should be understood that embodiments are wide ranging and varied. For example, speech audio such as created during an educational lecture, political speech, walking tour, comedy act, language translation and others are contemplated. Likewise, audio accompanying television and other video feeds such as movies, and video clips are also contemplated. Additionally, live, recorded and delayed streams may be used in various embodiments. Embodiments are not limited to audio data. In some embodiments use and manipulation of video and other data are contemplated as well.

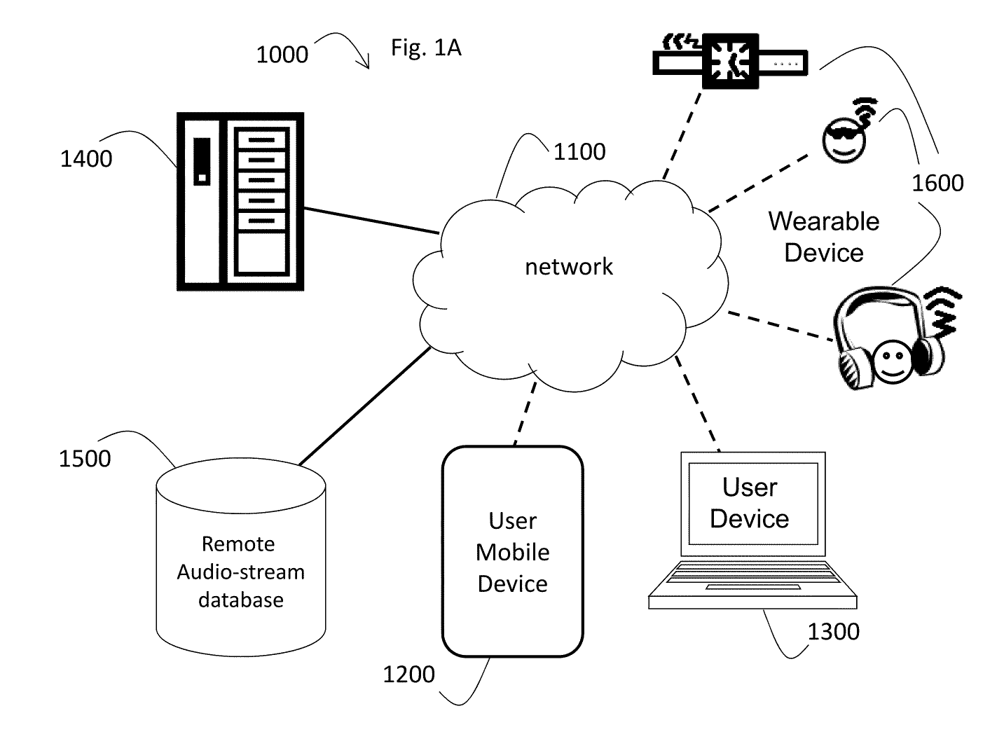

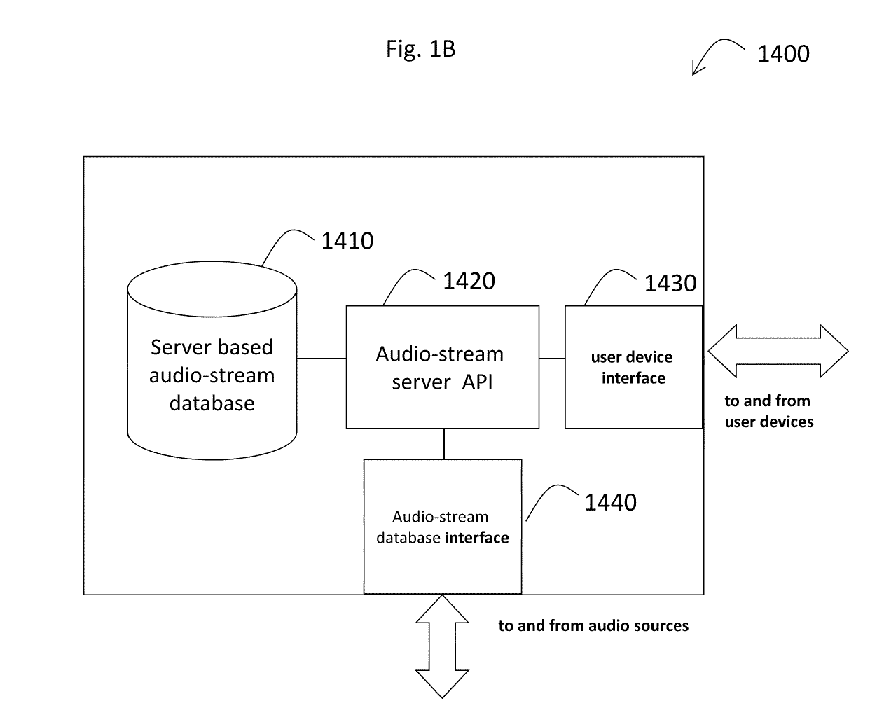

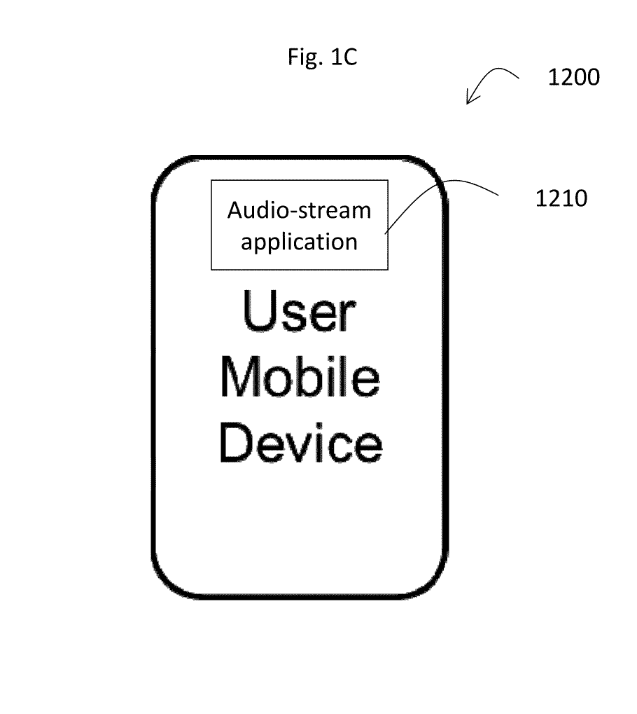

Turning to FIG. 1A, an example diagram of a basic network setup according to an embodiment of the present invention is shown.

In FIG. 1A, a system 1000 generally includes an audio-stream server system 1400 and a remote audio-stream database 1500. Either audio-stream server system 1400 or remote audio-stream database 1500 may be distributed on one or more physical servers, each having one or more processors, memory, an operating system, input/output interfaces, and one or more network interfaces all known in the art. Also included are a plurality of end user devices 1200, 1300, 1600 coupled to a network 1100, such as a public network (e.g., the Internet and/or a cellular-based wireless network) or a private network to which audio-stream server 1400 and remote audio-stream database 1500 may also be coupled. User devices include, for example, mobile device 1200 (e.g., phone, tablet, etc.), desktop or laptop devices 1300, wearable device 1600s (e.g., watch, bracelet, glasses, audio headphone receivers), specialized media reception devices, other devices with computing capability and network interfaces, and so on. The remote audio-stream database 1500 includes, for example, audio files stored in memory and operable for accessing and playback. In some embodiments remote audio stream database 1500 and/or audio stream server 1400 may be dedicated third party platforms.

Turning to FIG. 1B, an example diagram of a network connected audio-stream server system according to an embodiment of the present invention is shown.

In FIG. 1B, a diagram of an audio-stream server system 1400 according to an embodiment is shown. An audio-stream server system 1400 includes a user device interface 1430 implemented with technology known in the art for communication with user devices 1200, 1300. Audio-stream server system 1400 also includes an audio-stream database interface 1440 implemented with technology known in the art for communication with audio-stream database 1500. Audio-stream server system 1400 may further include an audio-stream server application program interface (API) 1420 that allows interaction between server based audio stream database 1410 and user devices 1200, 1300. Audio-stream server API 1420 is coupled to the server based audio-stream database 1410 to store and access audio-stream files as will be described below. Database 1410 may be implemented with technology known in the art, such as relational databases and/or object oriented databases.

Turning to FIG. 1C, an example diagram of a user device according to an embodiment of the present invention is shown.

In FIG. 1C, a diagram of a user mobile device 1200 according to an embodiment is shown. User mobile device 1200 includes a network connected data-stream application 1210 that is installed in, pushed to, or downloaded to the user mobile device 1200. User mobile device may be any of a number of past, contemporary, and future user mobile devices including but not limited to smart-phones, media players, laptops, tablet computers, videogame consoles and others. These devices typically consist of displays showing graphical user interfaces to users; internal processors; internal memory; power sources such as rechargeable batteries; user input capabilities such as touchscreens, keyboards, joysticks, and others; and wireless connectivity hardware such as wireless transceivers. Often they have speakers and headphone jacks to plug in headphones.

Generally, a network connected data-stream application 1210 is installed in, pushed to, or downloaded to user mobile device 1200. The user of data-stream application 1210 in some embodiments may be required to create a user account including a login name and password. In other embodiments no such account is required. Data-stream application 1210 may have at least two modes of operation that a user may select. One mode may be stream controller mode and one mode may be receiver mode. In many embodiments users of data-stream application may easily and quickly switch between modes.

In an example embodiment, a stream controller mode may control information sent in a communication network, particularly audio stream information. Information may be sent in communication networks via packets, sometimes called frames. Packets generally include two types of data, namely control data and payload data. Control data provides information that a communication network may use in order to deliver the packet to the correct location. Control data may include network addresses of the source and the destination, error detection codes, sequence information, time to live information, and others. Payload data typically is data a user wishes to transmit or receive. Payload data may be encrypted in some applications. Control data is typically located in portions of the packet called packet headers and packet trailers while payload data may be located in the between packet headers and packet trailers.

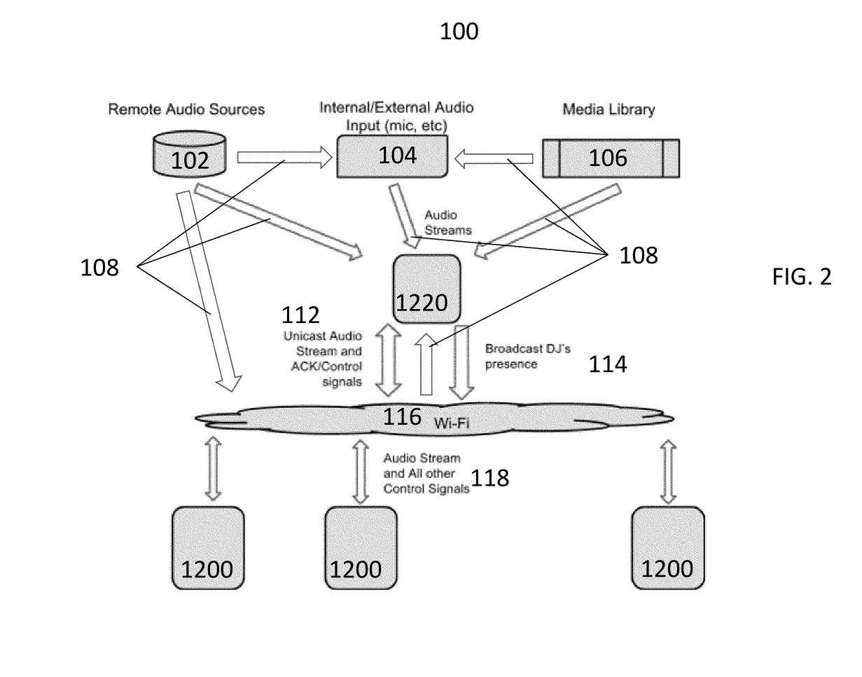

Turning to FIG. 2, a block diagram depicting an example embodiment of a typical network structure and flow chart for data in a Wi-Fi network in accordance with the present invention is shown.

In general, network structure and data flow 100 is shown. In the example embodiment, network structure includes stream controller 1220 receiving, accessing, or otherwise using audio streams 108 from remote audio sources 102, internal/external audio input 104, and/or media libraries 106.

In some embodiments internal/external audio input 104 may include input from devices such as microphones, turntables, mixers, music players such as tape decks, record players, eight-track players, radios, personal media devices, televisions and/or others. In some embodiments media library 106s may include locally saved music files stored in libraries such as databases. Media libraries may be organized according to numerous different cataloging methods including grouping music by artist, title, genre, date of acquisition, and others.

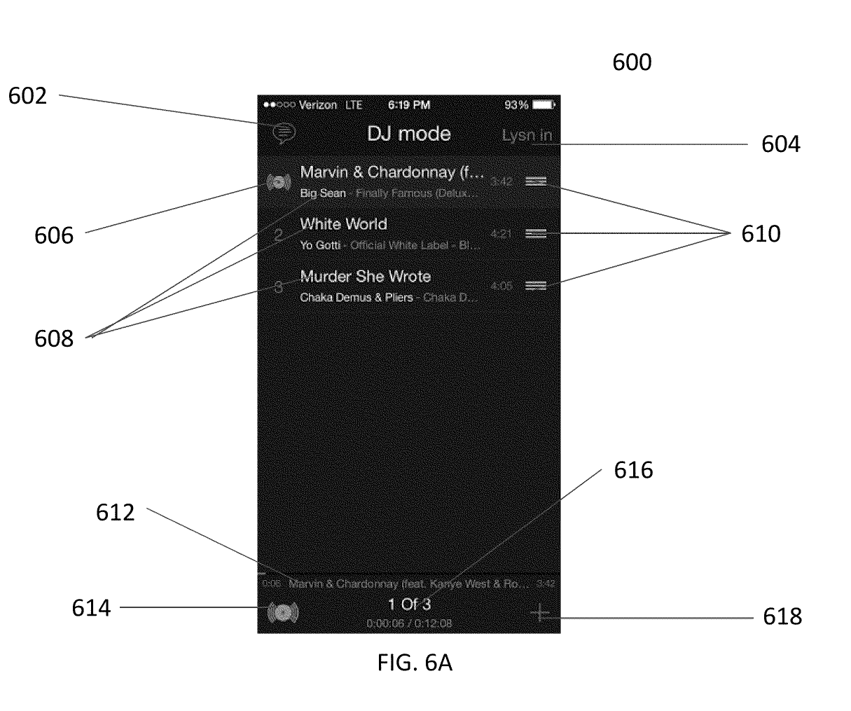

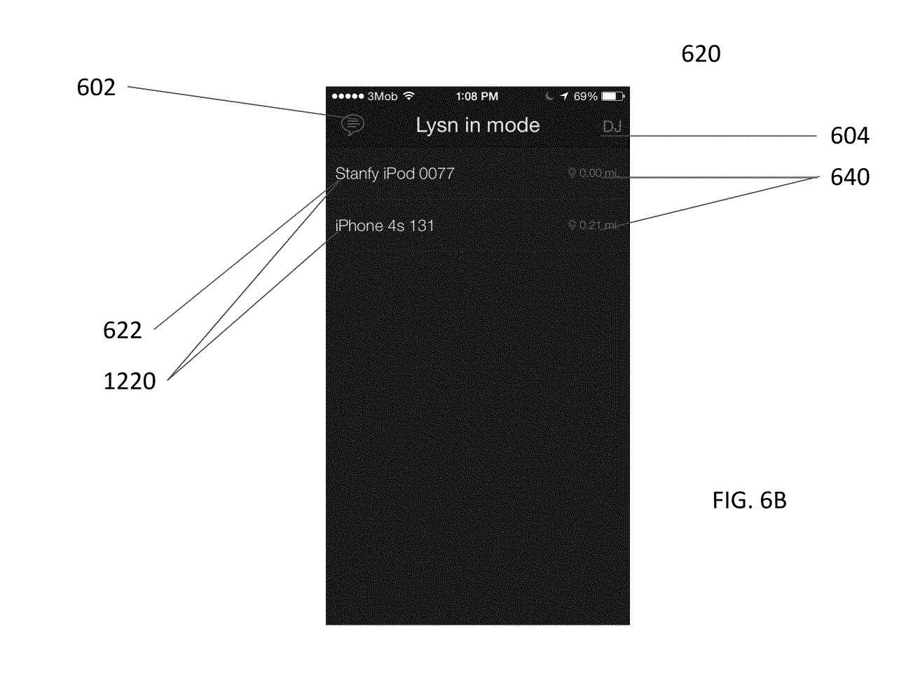

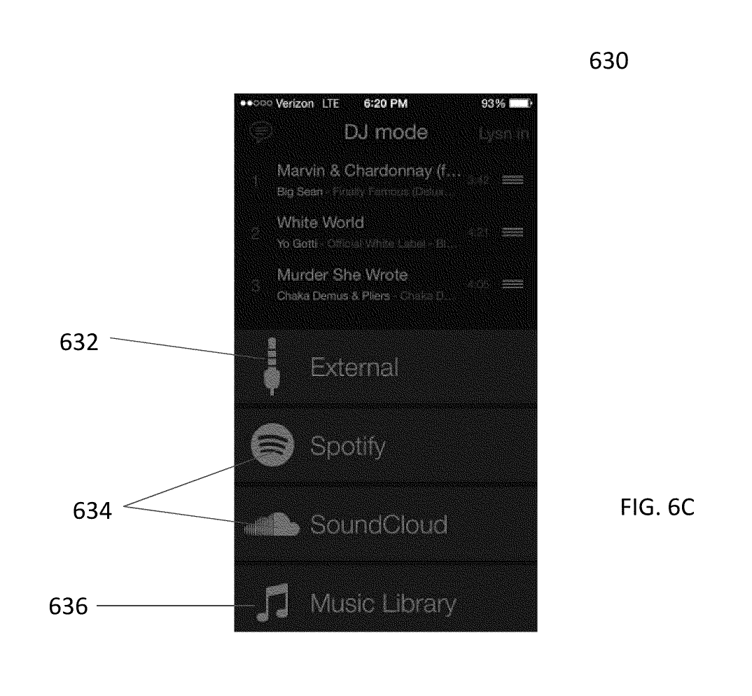

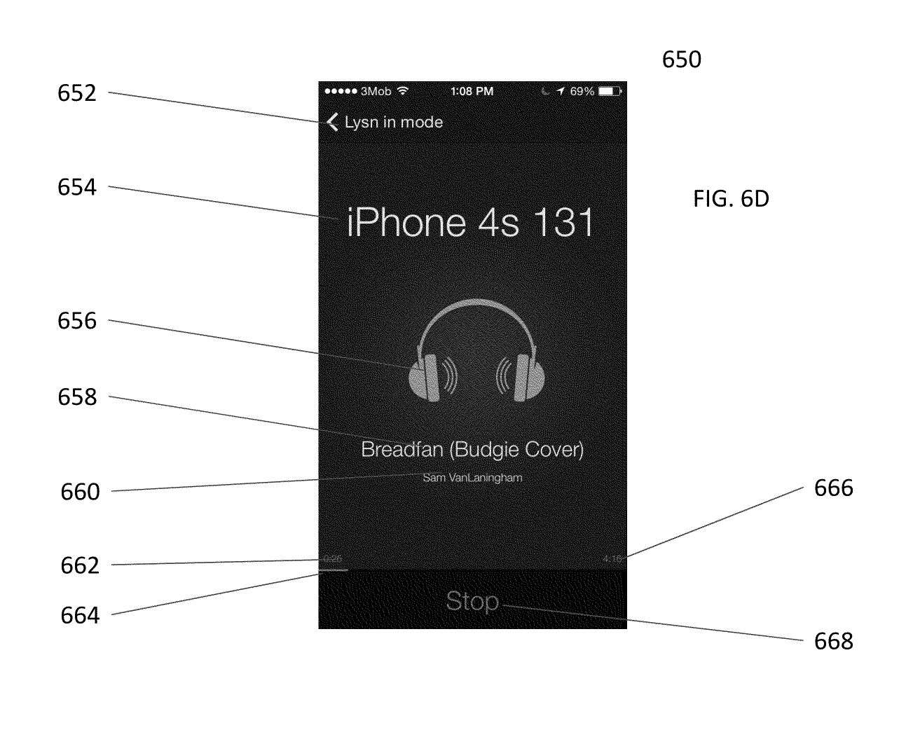

Stream Controller 1220 is a mobile device 1200 with data-stream application 1210 installed and a stream controller mode active. Stream Controller 1220 is operable to control audio streams multicasts or broadcasts for other mobile device 1200s to tune into. Any mobile device 1200 with data-stream application 1210 may be transitioned from a listening/receiving mode to a stream controller mode (and thus into Stream Controller 1220) using simple mode-change controls within data-stream application 1210, as shown in FIG. 6B. Likewise, any Stream Controller 1220 may be transitioned from stream-controller mode into a listening/receiving mode (labeled generically as mobile device 1200s) using simple mode change controls within data-stream application 1210, as shown in FIG. 6A. Although a single Stream Controller 1220 is shown in many figures in this application, multiple Stream Controller 1220s may exist on a single network and function similarly. This provides mobile device 1200s variability in selecting which Stream Controller 1220 to follow, tune-in, or listen when in listening/receiving mode. In some embodiments additional functionality may be provided such as linking multiple Stream Controller 1220s, toggling, or otherwise communicating between Stream Controller 1220s.

Remote audio sources 102 may be remote audio-stream databases 1500 or server based audio-stream database 1410s, among others. Remote audio source 102s may also include musical instruments, microphones, and other devices used to create audio streams for transmission over wired or wireless networks to Stream Controller 1220 and communicatively coupled to data transceivers. In some embodiments remote audio sources 102 may be third party audio source systems such as SoundCloud® by SoundCloud Limited, Spotify® by Spotify, Ltd., Pandora® by Pandora Media, Inc., or others. In some embodiments Stream Controller 1220 may access other mobile device 1200s storing audio as remote audio source 102s.

Media library 106 may be a library or other database of audio, visual and/or other data which is stored. In some embodiments media library 106 may be stored on portable storage media, such as on a USB flash drive or other memory stick; stored on locally connected equipment such as a laptop, computer, media player, or other device which may be wire-connected to Stream Controller 1220; or stored on mobile device 1200 itself acting as Stream Controller 1220. In some embodiments Stream Controller 1220 may access other wire-connected or wirelessly connected mobile device 1200s storing audio as media library 106s.

Internal/External Audio input 104 may include one or more audio player and/or manipulation devices. Examples of audio player and/or manipulation devices include turntables, sequencers, audio mixers, crossfaders, effects units, digital controller hardware, samplers, electronic musical keyboards, drum machines, guitars, basses, microphones, televisions, cable or satellite television receivers, Compact Disc (CD) players, Digital Video Disc (DVD) players, High Definition (HD) DVD players, Blu-ray™ players, Versatile Multilayer Disc players, EVD players, AM/FM radios, and other controllers, devices, and musical instruments. In some cases Internal/External Audio input 104 may receive audio stream 108s directly or indirectly from media library 106 and/or remote audio sources 102. Depending on the type of internal/external audio input 104 device used, the audio stream 108 may be altered, modified, or otherwise changed before forwarding the audio stream 108 along to Stream Controller 1220.

As a first example, if Internal/External Audio input 104 is an audio mixer equipped with a crossfader, a mobile device 1200 acting as Stream Controller 1220 may be able to smoothly transition from one song to another song using different audio stream 108s. As a second example, a user operating Stream Controller 1220 may use a microphone to talk or sing over audio tracks from audio stream 108s while they are playing so as to introduce songs to listeners operating mobile device 1200s in receiver mode. As another example, a guitarist may connect electric guitar as Internal/External Audio input 104 operatively coupled with Stream Controller 1220 in order to play the guitar over pre-recorded music tracks during a live guitar performance. Multiple Internal/External Audio input 104 devices may be used in various setups and a myriad of such combinations exist.

After activating stream controller mode to transition a mobile device 1200 into Stream Controller 1220, Stream Controller 1220 may select a particular audio stream 108 from audio stream 108s it is receiving if more than one is being sent at a time. In some embodiments Stream Controller 1220 may access and receive audio stream 108s over a network (such as when remote audio sources 102 are selected). In an example embodiment a network is Wi-Fi network 116. Stream Controller 1220 may then unicast the audio stream and ACK/Control (acknowledgement/control) signals 112 to or over Wi-Fi network 116. In some embodiments Wi-Fi network 116 may be another private or semi-private network such as Bluetooth, or others. Alternatively, Wi-Fi network 116 may be replaced or supplemented by wired networks in some embodiments. Prior to, contemporaneous with, or subsequent to sending signals 112 to or over Wi-Fi network 116, Stream Controller 1400 may advertise or otherwise broadcast Stream Controller 1220's presence 114 to or over Wi-Fi network 116. Mobile device 1200s may receive audio stream 108s and audio control signals 118 from Wi-Fi network 116 and may process audio stream 108s and convert them into audio for listening using headphones, although speakers or other audio output equipment may also be used to play audio from audio stream 108s.

The system and methods described herein contemplate that many mobile device 1200s may switch modes based on user choice such as an operating mode change and become Stream Controller 1220s. The alternative is also true in that a Stream Controller 1220 has the functionality to become a listening mobile device 1200 upon a user choice such as an operating mode change.

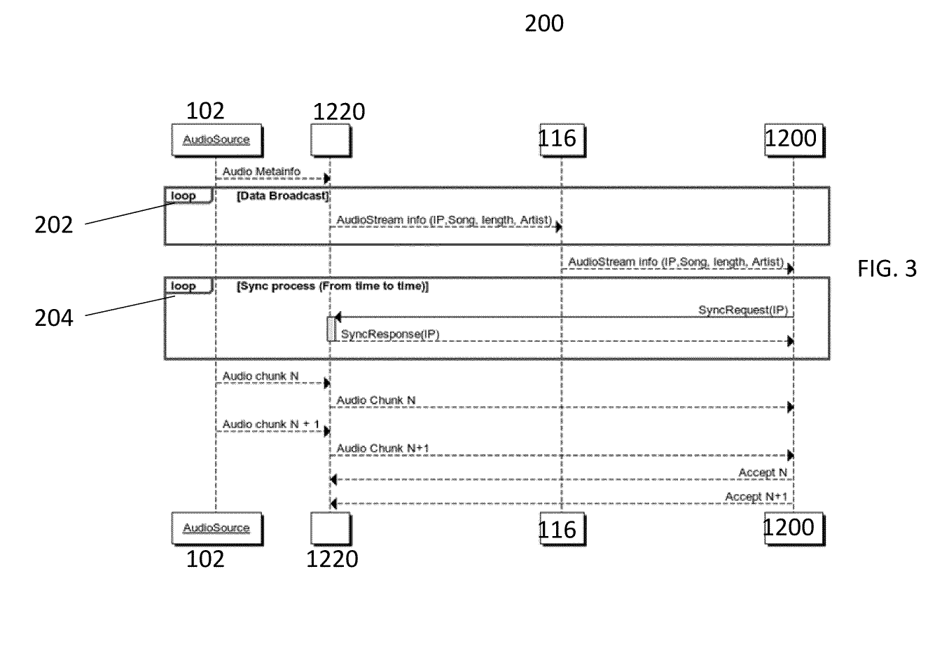

Turning to FIG. 3, a sequence diagram depicting a typical data sequence over a Wi-Fi network 116 in accordance with the present invention is shown.

In general, FIG. 3 shows a typical data sequence 200 over a Wi-Fi network 116, particularly the interaction between remote audio source 102, Stream Controller 1220, Wi-Fi 116, and mobile device 1200.

In the example embodiment audio meta-info or metadata is first sent from remote audio source 102 to Stream Controller 1220. Examples of meta-info may include copyright information, song information, song length, artist name, composer, beats per minute (bpm), musical key, or others.

Next, Stream Controller 1220 begins data broadcast loop 202. Data broadcast loop 202 generally involves Stream Controller 1220 transmitting audio stream information (AudioStream info in the diagram) to a Wi-Fi router on Wi-Fi network 116. In some embodiments this audio stream information includes an Internet Protocol (IP) address of Stream Controller 1220 and/or one or more remote audio source 102s. This information is useful for mobile device 1200s in order to make appropriate connections to receive the correct audio stream. Data broadcast loop 202 may continue perpetually until Stream Controller 1220 terminates it by ending the concert, event, or other activity. After audio stream information is transmitted by Stream Controller 1220 to Wi-Fi 116 it may be broadcasted by Wi-Fi 116 and received by mobile device 1200s. Inclusion of meta-info at earlier steps allows mobile device 1200s to display the meta-info in the audio stream application 1210 so that the user may view information about the audio stream 108 that Stream Controller 1220 is using.

Also included in this diagram is sync process loop 204 which may occur periodically or non-periodically as required by the particular network conditions. Sync process loop 204 includes mobile device 1200 sending SyncRequest (IP) signals to Stream Controller 1220. This means that mobile device 1200 is requesting a status update of the AudioStream Info in order to ensure the current stream is being received. In response to SyncRequest (IP) signals, Stream Controller 1220 sends back SyncResponse (IP) signals to mobile device 1200. In a typical embodiment, SyncResponse (IP) signal may include 8 bytes each of clientID data, clientTime data, serverID data, and serverTime data. ClientID data may be a copy of the received client ID from the SyncRequest, clientTime data may be a copy of the client clock time from the original SyncRequest, serverID data may be a unique ID for the server, and serverTime data may be a current server clock time.

After Stream Controller 1220 completes data broadcast loop 202, a first segment or chunk of audio data N is sent to Stream Controller 1220. Stream Controller 1220 may then send this first audio chunk N to mobile device 1200, typically by broadcasting it via network 116. The process repeats for a next audio chunk N+1 (Stream Controller 1220 receives it from audio source 102 and then sends it to mobile device 1200 via network 116). Subsequent to receiving some or each audio chunk, mobile device 1200 may send Accept N which is an acknowledgement signal. For each audio packet with index N received by mobile device 1200, mobile device 1200 will respond by sending an acknowledgement packet of index N. Mobile device 1200 may perform base checks on incoming packet or frame structure to determine whether data is valid or corrupt. If corrupt, the packet or frame may simply be skipped and no acknowledgment packet sent. Stream Controller 1220 may store information about acknowledgement data received from mobile device 1200s. In cases where acknowledgement packets are not received after a predetermined time threshold Stream Controller may resend the packet associated with the missing acknowledgement packet. Numerous error checking methods are known in the art and many may be appropriate in various embodiments herein.

Audiochunk data in a typical embodiment may include 8 bytes each of serverPlayingPosition and serverincrementationTime. ServerPlayingPosition may be a current server playing position such as the ID of an audio chunk that was played last. ServerincrementationTime may be a time when the last audio chunk was loaded to an AudioQueue or otherwise played. Time in this case does not necessarily mean current time in the real-world but may mean time that has passed from the last device boot in nanoseconds.

Each packet sent in the system may include a header with 2 bytes mHeader, 2 bytes mVersion, and 8 bytes mPacketID. MHeader may be a program identifier such as “LI”, mVersion may be a program version “0x02” and mPacketID may be a packet identifier.

It should be noted that additional steps may not be shown herein for brevity. For example, although Stream Controller 1220 and mobile device 1200 are shown as transmitting directly to each other in the diagram there may be actual steps of sending to a Wi-Fi router on Wi-Fi network 116 which are not shown in detail but would are understood by those in the art may occur.

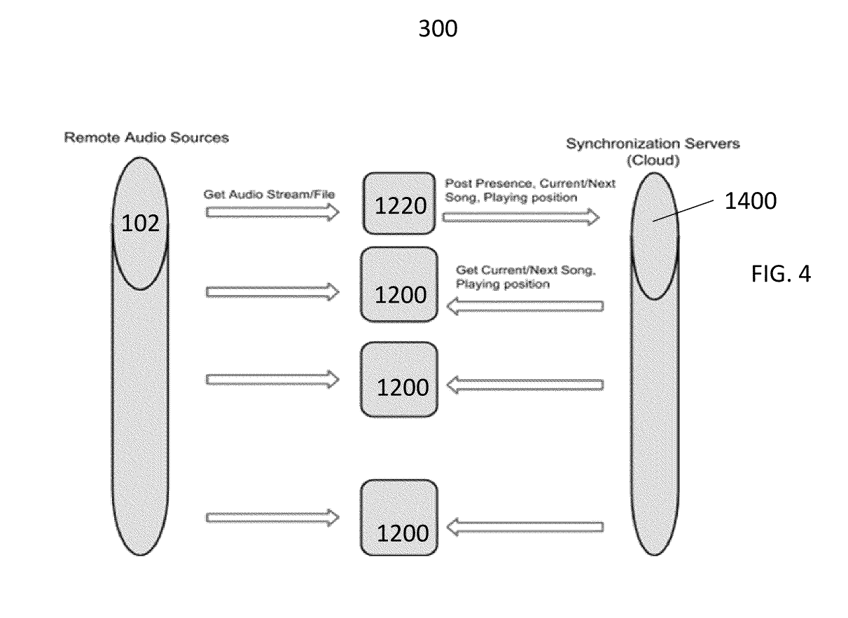

Turning to FIG. 4, a block diagram depicting an example embodiment of a typical network structure and flow chart for data in a 3G network in accordance with the present invention is shown.

In the example embodiment typical network architecture and flow chart for data in a 3G network 300 includes Stream Controller 1220, remote audio source 102s, mobile device 1200s, and synchronization server 1400s.

In the example embodiment, Stream Controller 1220 generally will access one or more remote audio source 102s over a 3G network. In some embodiments a 4G network may be used.

Stream Controller 1220 and mobile device 1200s are operable to receive audio streams and/or files from remote audio sources 102 over one or multiple 3G networks. In the example embodiment Stream Controller 1220 will first post a presence notification to synchronization servers 1400. Simultaneously or subsequently, Stream Controller 1220 will begin transmitting current and/or next song information as well as playing position information to synchronization servers 1400. Playing position information may also be periodically transmitted to synchronization servers 1400 in order to keep mobile unit 1200s current which are following the broadcast. Mobile device 1200s are able to communicate with synchronization servers 1400 to determine current and next song information and playing position information. Mobile Device 1200s are also operable to communicate or at least receive information from remote audio source 102s in the form of audio streams and/or files.

Although not shown in FIG. 4, other elements may also be included similar to FIG. 2 such as Internal/External Audio Input 104s and media library 106s with similar functionality.

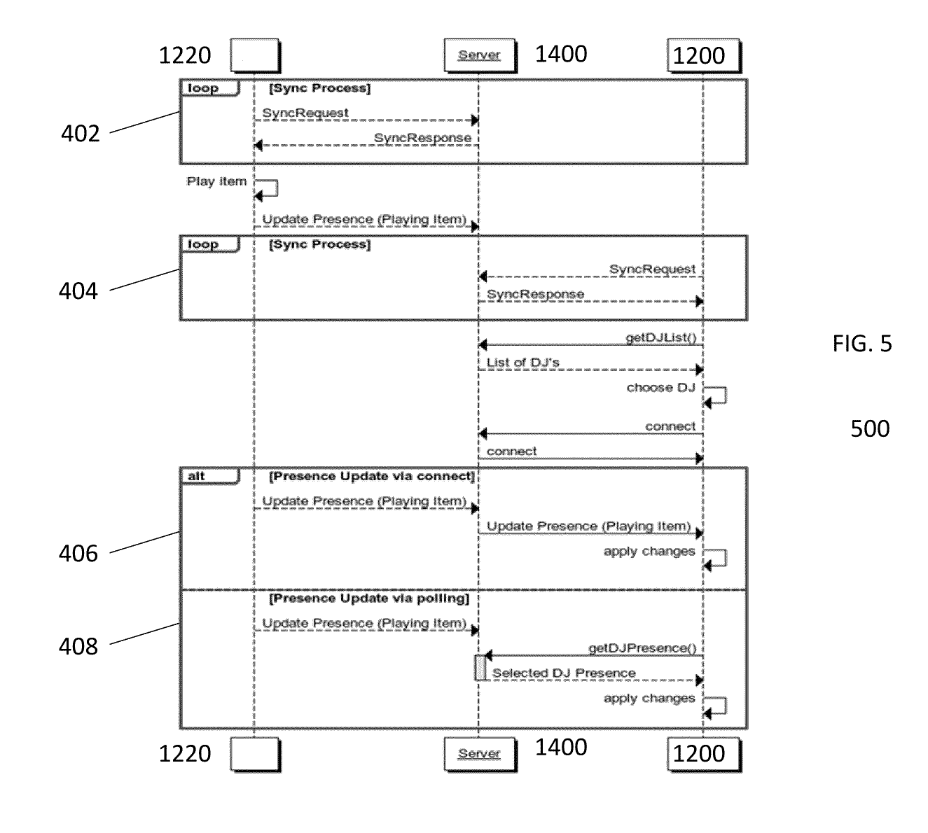

Turning to FIG. 5, a sequence diagram depicting a typical data sequence over a 3G network in accordance with the present invention is shown.

In the example embodiment data sequence over a 3G network 400 generally shows the interaction between Stream Controller 1220, synchronization server 1400, and mobile device 1200 including Stream Controller-Server sync process loop 402, mobile device-Server sync process loop 404, presence update via connection loop 406, and presence update via polling loop 408.

Stream Controller-Server sync process loop 402 generally includes Stream Controller 1220 sending a SyncRequest to synchronization server 1400 via the network similar to the description above. Upon receiving the SyncRequest from Stream Controller 1220, synchronization server 1400 sends SyncResponse back to Stream Controller 1220 similar to that described. In some embodiments “pre-downloaded” data files may be used for playback. In some embodiments data files may be streamed directly from a server.

After SyncResponse is received from synchronization server 1400, Stream Controller 1220 may begin playing an audio track. Stream Controller 1220 will then notify server of an updated presence such as what audio track is currently being played and/or what audio track is upcoming.

Mobile device-Server sync process loop 404 generally includes mobile device 1200 sending a SyncRequest to synchronization server 1400 via the network. Upon receiving the SyncRequest from mobile device 1200, synchronization server 1400 sends SyncResponse to mobile device 1200 including information as previously described. The functionality over 3G and Wi-Fi is similar in this loop.

After mobile device-Server sync process loop 404, mobile device 1200 may request a list of current Stream Controller 1220s from synchronization server 1400. A list of current Stream Controller 1220s will typically include Stream Controller 1220s which have successfully completed Stream Controller-Server sync process loop 402. Synchronization server 1400 may use additional criteria in some embodiments to determine a list of current Stream Controller 1220s such as determining which connected Stream Controller 1220s are actually playing audio tracks by evaluating whether Stream Controller 1220s have sent recent updates to synchronization server 1400.

When synchronization server 1400 determines which Stream Controller 1220s are active it will respond to mobile device 1200 by sending a list. After receiving the list mobile device 1200 will notify the user by displaying the list and requesting user input in the form of choosing a Stream Controller 1220. Once the user has chosen a Stream Controller 1220, mobile device 1200 will notify synchronization server 1400 and synchronization server 1400 will respond by sending the appropriate stream from the chosen Stream Controller 1220.

Presence update via connection loop 406 generally includes Stream Controller 1220 sending presence update information, such as current playing information, to synchronization server 1400 periodically via a network. In some embodiments this may mean sending presence update information when an audio track changes or when Stream Controller 1220 manipulates the audio track in some manner. In some embodiments this may mean sending presence update information when an audio stream changes. In some embodiments this may mean sending presence update information when an audio source changes. In some embodiments this may mean sending presence update information at regular time intervals or other times, such as thirty seconds before an audio track will end, or others. In the example embodiment synchronization server 1400 may update an internal register to track changes in presence update information. In the example embodiment synchronization server 1400 sends presence update information to mobile device 1200s via the network. Mobile device 1200s receive the presence update information, process it, and may then use it accordingly, such as to apply changes, play current audio, or otherwise update their internal information for upcoming audio tracks.

Presence update via polling loop 408 includes Stream Controller 1220 sending update presence signals to synchronization server 1400, such as a currently playing item. Mobile device 1200s may then receive updated information on a current or multiple current Stream Controller 1220s by polling synchronization server 1400 about current Stream Controller 1220s presences. Based on the current presence, mobile device 1200s may update the currently playing item.

Presence update via connection loop 406 and presence update via polling loop 408 are generally alternative ways for mobile device 1200s to receive updated information although in some embodiments they may function in a complementary fashion.

Turning to FIG. 6A, an example embodiment of a user interface of a mobile device 1200 in Stream Controller mode 600 is shown. Numerous controls, buttons, and indicators are shown which allow a user to operate as Stream Controller 1220.

Selecting Comment button 602 allows a user to provide comments to the system operator for improved system operability. Mode toggle button 604 allows users to toggle between stream controller mode and listener/receiver mode. In operation it changes user interface views from Stream Controller mode 600 to Listener/Receiver mode 620 shown in FIG. 6B. Currently track indicator 606 shows the user what track is currently selected and playing. Track listing 608 shows the user what tracks are currently set to play in the current playlist. Tracks may be removed from the current listing by swiping to the left. A trash icon may then appear on the song listing and the track may be removed by selecting the trash icon. Order change button 610s allow the user to drag and drop in order to change the track order (for instance, by swapping the position of tracks 2 and 3). Audio meta-info 612 shows the user meta-info about the currently playing track such as time elapsed, total time, track title, and others in various embodiments. Operating mode indicator 614 shows a user that the device is currently an active Stream Controller 1220. Current track position 616 shows a user where in the playlist the user is currently located. Audio stream addition button 618 allows users to add additional audio streams by displaying Audio stream access screen 630 shown in FIG. 6C.

Turning to FIG. 6B, an example embodiment of a stream controller selection user interface 620 for a user in Listener/Receiver mode is shown. Selecting Comment button 602 allows a user to provide comments to the system operator for improved system operability. Mode toggle button 604 allows users to toggle between stream controller mode and listener/receiver mode. In operation it changes user interface views from Listener/Receiver mode 620 Stream Controller mode 600 shown in FIG. 6A. Current Stream Controller list 622 will display Stream Controller 1220s within the user's selected network. Also included are distance marker 640s indicating an approximate and/or exact distance between the user's mobile device and each Stream Controller 1220. Selecting a Stream Controller 1220 to tune may take a user to a tuned-in user interface screen 650 as shown in FIG. 6D.

Turning to FIG. 6C, an example embodiment of a user interface of Audio stream access screen 630 is shown. External access button 632 will provide users access to external audio connections. Remote audio source button 634s allow users to access third party sources in the example embodiment. In some instances third party sources may require login information that may be inputted directly into the system. In other instances third party sources may allow users to search and add audio tracks directly. Music library button 636 allows users to add music choices from the users own music library. In the example embodiment the music library is a music library stored locally on mobile device 1200.

Turning to FIG. 6D, an example embodiment of a tuned-in user interface screen 650 is shown. In the example embodiment a user has selected a stream controller to receive data from. The stream controller title 654 shows the user the name of the current stream controller. Back button 652 may return the user to the previous screen, for instance a stream controller selection user interface 620 as shown in FIG. 6B. Status icon 656 may show a status of the current stream controller such as paused, playing, stopped, or others using different graphical or other indicators. In the example embodiment, headphones with wave pulses coming from the ear pieces may indicate that the stream controller is in play mode. Alternatively or additionally, status icon 656 may display whether data is being received from the stream controller.

Title 658 may display the title of a current data stream, such as the title of a current audio stream which is playing. Author 660 may indicate the author of a current data stream. In an example embodiment where music is being received, Author 660 may be an artist, composer, arranger, creator or other entity. Time elapsed indicator 662 may show the time elapsed since a data stream began or the time elapsed since a portion of a data stream began. Time remaining 666 may indicate the time remaining until a data stream expires or the time remaining until a portion of a data stream expires. Progress indicator 664 may show the progress of a current data stream or portion of a current data stream. For instance, in the example embodiment, a small percent of the data stream has elapsed and thus progress indicator 664 has an equivalent small percent shown of a full one-hundred percent. Stop button 668 may temporarily pause or permanently stop a current data stream from the currently selected stream controller.

Although audio data is the primary focus of the above description, it should be understood that the systems and methods described herein are not limited to audio data. In some instances video, gaming or other data may be shared, altered, controlled, and otherwise distributed according to the methods and systems described herein. Likewise, other processing, and/or data file-sharing, manipulation, management etc. may be accomplished using the methods and systems described herein.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A non-transitory computer readable medium including instructions that are configured to cause a computer system to operate as a data-stream controller or receiver by performing a method comprising:
enabling a data-stream controller mode on the computer system when selected by a computer system user;
accessing a data file including data file information located on a computer readable memory;
transmitting the data file information over a computer network to a receiving unit;
responding to synchronization requests from the receiving unit;
transmitting data chunks to the receiving unit;
retransmitting data chunks if an acknowledgement is not received from the receiving unit; and
enabling a data-stream receiver mode on the computer system when selected by a computer system user.

2. The non-transitory computer readable medium including instructions that are configured to cause a computer system to operate as a data-stream controller or receiver by performing a method according to claim 1, wherein the data file is an audio data file.

3. The non-transitory computer readable medium including instructions that are configured to cause a computer system to operate as a data-stream controller or receiver by performing a method according to claim 1, wherein enabling a data-stream controller mode on the computer system when selected by a computer system user further comprises:
causing the computer system to change operating modes from a data-stream receiver to a data-stream controller when a mode change is option is selected while the computer system is operating as a data-stream receiver.

4. The non-transitory computer readable medium including instructions that are configured to cause a computer system to operate as a data-stream controller or receiver by performing a method according to claim 1, wherein the computer readable memory is accessed over a network.

5. The non-transitory computer readable medium including instructions that are configured to cause a computer system to operate as a data-stream controller by performing a method according to claim 1, wherein the computer readable memory is accessed locally.

6. The non-transitory computer readable medium including instructions that are configured to cause a computer system to operate as a data-stream controller or receiver by performing a method according to claim 1, wherein the data chunks may be portions of the data file that are modified or supplemented with additional data based on user inputs prior to transmitting the data chunks to the receiving unit.

7. The non-transitory computer readable medium including instructions that are configured to cause a computer system to operate as a data-stream controller or receiver by performing a method according to claim 1, wherein the computer network is a Wi-Fi network.

8. The non-transitory computer readable medium including instructions that are configured to cause a computer system to operate as a data-stream controller or receiver by performing a method according to claim 1, wherein the computer network is a cellular network.

9. A data-stream controller comprising:
a user device comprising at least one processor coupled to a computer readable memory, a power source, a display and a data transceiver;
the computer readable memory storing instructions which, when executed by the at least one processor, cause the user device to operate in a data-stream controller mode.

10. The data-stream controller of claim 9, wherein the computer readable memory stores instructions which, when executed by the at least one processor, cause the user device to operate in a data-stream receiver mode.

11. The data-stream controller of claim 9, wherein operating in a data-stream controller mode further comprises:
sending a first presence notification to data-stream receivers via a network, wherein the first presence notification includes MetaInfo regarding a data-stream;
sending subsequent presence notifications to data-stream receivers via the network at least when the data-stream is updated.

12. The data-stream controller of claim 9, wherein operating in a data-stream receiver mode further comprises:
presenting a user interface to a user via the display with an option to follow a data-stream controller of a plurality of data-stream controllers which have sent at least one presence notification each.

13. The data-stream controller of claim 9, wherein operating in a data-stream controller mode further comprises:
modifying a data-stream using a local data stream modifier before a data-stream receiver can receive the data-stream.

14. The data-stream controller of claim 9, wherein operating in a data-stream controller mode further comprises:
modifying a data-stream using a remote data stream modifier before a data-stream receiver can receive the data-stream.

15. The data-stream controller of claim 9, wherein operating in a data-stream controller mode further comprises:
presenting a user with the option to select data for a data-stream from at least one local data and remote data sources.

16. The data-stream controller of claim 14, wherein a remote data source further comprises a third-party database.
